(19) United States
(12) Patent Application Publication
(10) Pub. No.: US 2011/0151210 A1
(43) Pub. Date: Jun. 23, 2011

(54) METHOD FOR PRODUCING A LASER-INSCRIBABLE FILM WITH METALLIC SURFACE LUSTER

(75) Inventors: Michael Siebert, Wedel (DE); Philipp Preuss, Neuenhaus (DE)

(73) Assignee: tesa SE, Hamburrg (DE)

(21) Appl. No.: 12/994,229

(22) PCT Filed: Aug. 28, 2009
(86) PCT No.: PCT/EP09/61123

§ 371 Date: Jan. 24, 2011

(30) Foreign Application Priority Data
Sep. 9, 2008 (DE) 10 2008 046 460.0

(51) Int. Cl. B32B 3/10; B32B 15/02; B05D 1/36; C08J 7/18

(52) U.S. Cl. 428/207; 428/457; 428/336; 427/404; 427/514

(57) ABSTRACT

The invention relates to a method for producing a laser-inscribable film with metallic surface luster, wherein at least one laser-inscribable layer, i.e. an engraving layer, is applied to a support, in particular directly onto the support. According to the invention, a gloss layer is applied to the engraving layer, said gloss layer containing metal gloss pigments.

This application is a 371 of PCT/EP2009/061123 filed Aug. 28, 2009 which claims priority of German application no. 10 2008 046 460.0 filed Sep. 9, 2008.

The present invention relates to a method for producing a laser-inscribable film with metallic surface luster having the features described hereinbelow.

For the identification of parts on vehicles, machines, electrical and electronic devices, packaging etc. increasing use is being made of technical labels, for example as type plates, as control labels for process flows, as security labels or as guarantee and test badges.

In order to inscribe such plates or labels, powerful controllable lasers are widely used, with the aid of which markings such as script, codings, barcodes and the like can be produced. Stringent requirements are placed on the material to be inscribed. For instance, it should be possible to carry out the inscribing rapidly, the resolution capacity should be high, application should be simple and the material should have a high resistance to mechanical, physical and chemical effects. Common materials, for example printed paper, anodized or lacquered aluminum or PVC films do not fulfill all these requirements.

The prior art (EP 1 440 133 B1) discloses a laser-inscribable film which fulfills the requirements mentioned above. In order to produce this film, an engraving layer based on a UV-curable lacquer is printed onto a support carrier film by the flexographic printing method. The engraving layer is used for the laser inscribing, by locally ablating it by laser irradiation. Over the engraving layer, a base layer of an electron beam-curable acrylate lacquer is applied. The base layer is formed so as to be much thicker than the engraving layer, so that full ablation during the laser inscribing is prevented. It is used to provide contrast after the inscribing of the engraving layer, by the base layer showing through at the positions where the printing lacquer layer has been removed. The two layers are correspondingly colored differently. This laser-inscribable film sufficiently fulfills the requirements described above in relation to efficient laser inscribing.

In what follows, an engraving layer refers to a layer into which an identifier can be introduced by means of laser irradiation, for example by local removal of the engraving layer, a local change of the optical properties (for example reflection, transmission, color) or the like.

In practice, laser-inscribable films are also known which have a metallic surface luster. In such films, metal gloss pigments are mixed with the engraving layer in order to achieve the metallic luster. The metal gloss pigments are distributed substantially homogeneously therein, in order to achieve a uniform effect. In the engraving layer, they act as colorants, as luster generators and as laser absorbers. The metal gloss pigments, however, have a much lower absorption coefficient compared with other laser absorbers, so that only a relatively low inscribing speed can be achieved with such films. Furthermore, undesired penetrations of the laser through the entire film material occur owing to the relatively low absorption coefficient, specifically in particular at the start of a marking step if a significantly stronger laser pulse then occurs, as is the case for example with solid-state lasers. Furthermore, such films have a significantly restricted laser working range for high-contrast inscribing. Variations of the laser intensity and variations of the layer thickness can therefore readily lead to low-contrast laser inscribing. Not least, the surface strength of laser-inscribable films with metallic luster is reduced since the pigments can protrude from the surface and thus form a good engagement surface for abrasive objects.

It is therefore an object of the present invention to provide a method for producing a laser-inscribable film with metallic surface luster and a corresponding film, with which the problems mentioned above are reduced and at the same time rapid laser inscribing is made possible.

The aforementioned object is achieved in a method for producing a laser-inscribable film with metallic surface luster having the features described hereinbelow.

The teaching of the invention is based on the fundamental concept of restricting the functionality of the engraving layer by the metallic luster no longer being provided by the engraving layer itself. Instead, an additional gloss layer is provided which contains the requisite metal gloss pigments. Although this additional gloss layer increases the process outlay, it nevertheless leads to a reduction of the complexity of the engraving layer. Because the engraving layer does not need to be adapted in respect of the metal gloss, better adaptation to the task in question, namely laser inscribing, is possible. In particular, other laser absorbers with a much higher absorption coefficient can be used. In particular, titanium dioxide and/or carbon black are suitable as laser absorbers.

In order to produce a laser-inscribable film with metallic surface luster, at least one laser-inscribable layer—engraving layer—is applied above a carrier. This single engraving layer, or alternatively a plurality of engraving layers, is or are preferably applied directly on the carrier.

The engraving layer can be applied by conventional coating methods. It is particularly preferable to apply the engraving layer by a printing method, in particular by a flexographic printing method, by means of which uniform layer application can readily be achieved. The printing method is suitable in particular when the engraving layer is formed from a printing lacquer. The engraving layers may be formed surface-wide or only partially. In particular, however, at least one engraving layer is formed surface-wide so as not to be spatially restricted in relation to the laser inscribing.

Here, a printing lacquer refers to any printing ink, regardless of whether it is transparent or colored. What is important is that the application is carried out by a printing technique.

According to the invention, a gloss layer is applied above the engraving layer. A configuration in which no interlayer is provided between the top engraving layer and the gloss layer is preferred, which is to say the gloss layer is arranged directly on the engraving layer. Nevertheless, alternative arrangements in which the gloss layer is arranged separated from the engraving layer by an interlayer may be envisaged, for example with a transparent interlayer, in order to achieve a 3D effect. The gloss layer is formed with metal gloss pigments, by which the metallic surface luster is achieved. Owing to the division of function between the engraving layer and the gloss layer, the possibility of inscribing the gloss layer is not necessary so that the comparatively low absorption efficiency of the metal gloss pigments is not a problem. In relation to the metal gloss pigments, there is therefore a greater range of selection since they do not have to be adapted to laser absorption. In particular, aluminum powder, bronze powder, pearl gloss pigments, gold powder, silver powder and/or copper powder may be envisaged as metal gloss pigments. The engraving layer, on the other hand, can be adapted expediently to its function of inscribing by laser absorption, for example through the addition of laser absorbers. Furthermore, any desired color configuration of the engraving layer is possible by adding color pigments, so that in particular multi-colored inscribing is made possible by the provision of a plurality of engraving layers.

Metal gloss pigments refer in particular to metal particles in platelet form, the average size of which lies between 1 μm and 100 μm. The average thickness of the metal particles is preferably between 50 nm and 250 nm. The configuration in platelet form has the advantage that, particularly when the metal gloss pigments are essentially aligned parallel to the surface extent of the gloss layer when the gloss layer is being formed, they offer only few points of attack on the surface. The scratch resistance is increased specifically by this. Yet even if a metal gloss pigment is detached from the layer, then in the event that the metal particles do not form a continuous layer, it is ensured that no further metal gloss pigments lying beside it are also detached. The luster effect is therefore only slightly impaired locally.

Owing to the division of tasks between the engraving layer and the gloss layer, the total proportion of metal gloss pigments is significantly reduced in comparison with the films known from the prior art, in which the metal gloss pigments are distributed homogeneously in a relatively thick layer, without thereby compromising the metal luster effect.

In a particularly preferred embodiment, the gloss layer is formed in such a way that it exclusively contains the metal gloss pigments as coloring pigments. These color pigments are conventionally integrated into an in particular transparent binder, preferably a polymer matrix, from which the gloss layer is then formed. In particular, the gloss layer is therefore formed exclusively from a transparent binder and the metal gloss pigments. In this way, impairment of the laser inscribing of the engraving layer can be avoided in the best possible way. As an alternative, however, the gloss layer may also be formed with further additives, for example in order to optimally adjust the adhesion or influence curing. For example, UV initiators may be supplied as additives.

In order to achieve a sufficient metallic surface luster, the gloss layer is advantageously applied with a layer thickness of at least about 0.5 μm. Furthermore, the layer thickness of the gloss layer should not be made too great, in order to keep the film structure as flat as possible and also to avoid impairment of the laser inscribing of the engraving layer by the gloss layer. Layer thicknesses of at most 5 μm have been found to be particularly suitable, preferably at most 3 μm. A small layer thickness furthermore has the advantage that far fewer metal gloss pigments are required in comparison with thicker layers.

Also preferably, the gloss layer is formed in such a way that the metal gloss pigments do not form a continuous film, but cover only a part of the surface of the gloss layer. For an optimal luster effect, the metal gloss pigments should cover an area of at least about 15%, preferably at least about 30%. In order to allow the best possible problem-free laser inscribing in this case, the metal gloss pigments should cover an area of at most about 80%, preferably at most about 60%.

In order to allow laser inscribing which is as efficient as possible, the absorption coefficient of the engraving layer is greater than the absorption coefficient of the gloss layer at least by a factor of 2, preferably at least by a factor of 5, more preferably at least by a factor of 10. This reference value for the absorption coefficient refers to the wavelength of about 1064 nm which is typical for an Nd:YAG laser. The desired adjustment of the absorption coefficient may, in particular, be achieved by mixing laser absorbers into the engraving layer. Titanium dioxide or carbon black are particularly suitable for this.

If the laser-inscribable film is intended to be protected particularly well against scratches etc., a transparent protective layer may additionally be applied onto the gloss layer. The transparent protective layer is in particular a protective layer based on a printing lacquer, so that the application may be carried out in particular by printing. The layer thickness of the protective layer should be formed between about 1 μm and about 5 μm.

For production of the laser-inscribable film, it has been found particularly advantageous for each layer, in particular each engraving layer and the gloss layer, respectively to be cured before a new layer is applied. Although this at first appears quite elaborate in terms of process technology, it does offer the advantage that the layer thickness can be adjusted particularly precisely and mixing of the various layers is avoided. This is particularly advantageous for precise subsequent laser inscribing, particularly in the case of a multi-colored structure. It has furthermore been found that UV-curing printing lacquers are particularly well-suited for the formation of laser films to be inscribed efficiently, particularly in relation to the adjustment of the layer thickness.

In order to obtain a stable, high-performance and versatile laser-inscribable film, the carrier is preferably formed with a layer thickness of between about 50 μm and about 200 μm.

Further details, features, aims and advantages of the present invention will be explained in more detail below with the aid of a drawing of a preferred exemplary embodiment. In the drawing,

### BRIEF DESCRIPTION OF THE DRAWINGS

FIG. 1 shows a schematic representation of the layer structure of a laser-inscribable film.

FIG. 1 shows a laser-inscribable film 1 which has metallic surface luster. This film comprises a carrier 2 and two laser-inscribable layers arranged above the carrier 2, namely the engraving layers 3, 4. The engraving layer 3 is arranged directly on the carrier 2 and is formed only partially. The engraving layer 4 is formed surface-wide and covers directly the engraving layer 3 and, at the positions where the engraving layer 3 is not present, the carrier 2. The two engraving layers 3, 4 are formed with different colors, so that multi-colored inscribing of the film 1 is possible. Here and preferably, the carrier 2 is also formed so that it is colored, in particular with a color having strong contrast in relation to the colors of the engraving layers 3, 4. When the engraving layer 4 is removed by laser irradiation, the color of the engraving layer 3 or of the carrier 2 is therefore shown, depending on whether or not the engraving layer 3 is present underneath. At the positions where the engraving layer 3 is provided, the engraving layer 3 may also be jointly removed by suitable selection of the laser parameters (pulse duration, intensity) in one inscribing cycle.

Above the engraving layer 4, a gloss layer 5 is provided surface-wide. The gloss layer 5 contains metal gloss pigments 6, here and preferably exclusively metal gloss pigments 6 as coloring pigments, and it forms a metallic surface luster. The metal gloss pigments 6 in the present case are metal gloss pigments 6 made of aluminum powder in the form of platelets. Besides the metal gloss pigments 6, the gloss layer 5 contains only a transparent binder as a further constituent, for example a polymer matrix. As an alternative, the gloss layer 5 may also contain as constituents a transparent binder, the metal gloss pigments 6 and further additives, for example UV initiators.

The gloss layer 5 is formed here and preferably as a printing lacquer layer, that is to say based on a printing lacquer which has been printed onto the engraving layer 4. In particular, a small layer thickness can be achieved in a particularly simple way by printing. The layer thickness of the gloss layer 5 is about 2.5 μm in the present case, and it should in principle advantageously be formed between about 1 μm and about 5 μm, preferably between about 1 μm and about 3 μm.

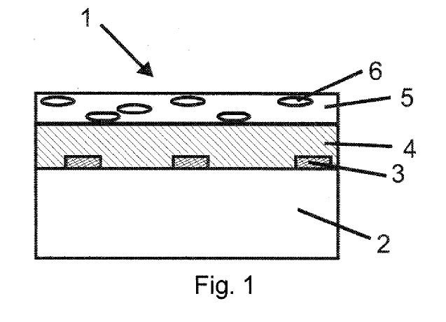

As can be seen in FIG. 1, the metal gloss pigments 6 in the gloss layer 5 do not form a continuous film, but instead here and preferably cover only about 40% of the total surface area. The lower the proportion of metal gloss pigments 6 in the gloss layer 5 is, the lower is the risk of surface impairment by detachment of metal gloss pigments 6 protruding from the layer. The risk of sizeable scratches is furthermore reduced, since even in the event that a metal gloss pigment 6 arranged on the surface is detached, it does not detach the further metal gloss pigments 6 with it since the multiplicity of metal gloss pigments 6 are arranged separated from one another. As an alternative or in addition, however, a transparent protective layer may also be provided above the gloss layer 5 in order to protect the surface as efficiently as possible from scratches and the like.

Furthermore, the metal gloss pigments 6 are here and preferably in the form of platelets with an average size of between 1 μm and 100 μm and an average thickness of between 50 nm and 250 nm.

1. A method for producing a laser-inscribable film with metallic surface luster, comprising applying at least one laser-inscribable layer (“engraving layer”) above a carrier, wherein a gloss layer is applied above the engraving layer, the gloss layer containing metal gloss pigments.

2. The method as claimed in claim 1, wherein the gloss layer is formed and printed as a printing lacquer layer.

3. The method as claimed in claim 1, wherein the gloss layer is formed exclusively with metal gloss pigments as coloring pigments.

4. The method as claimed in claim 1, wherein the gloss layer is formed exclusively from a transparent binder and the metal gloss pigments, or in that the gloss layer is formed from a transparent binder, the metal gloss pigments and further additives.

5. The method as claimed in claim 1, wherein the gloss layer is applied with a layer thickness of between about 0.5 μm and about 5 μm.

6. The method as claimed in claim 1, wherein the gloss layer is formed in such a way that the metal gloss pigments do not form a continuous film.

7. The method as claimed in claim 1, wherein the laser-inscribable film is formed in such a way that the absorption coefficient of the engraving layer is greater than the absorption coefficient of the gloss layer at least by a factor of 2.

8. The method as claimed in claim 1, wherein a transparent protective layer is applied onto the gloss layer.

9. The method as claimed in claim 8, wherein the protective layer is formed with a layer thickness of between about 0.5 μm and about 5 μm.

10. The method as claimed in claim 1, wherein the engraving layer is formed and printed as a printing ink layer.

11. The method as claimed in claim 1, wherein UV-curing printing inks are used, and/or each layer is cured before applying the next layer.

12. The method as claimed in claim 1, wherein at least one engraving layer is formed surface-wide.

13. The method as claimed in claim 1, wherein the engraving layer is formed with titanium dioxide and/or carbon black as laser absorbers.

14. The method as claimed in claim 1, wherein the engraving layer is applied with a layer thickness of between about 1 μm and about 10 μm.

15. The method as claimed in claim 1, wherein the carrier is formed with a layer thickness of between about 50 μm and about 200 μm.

16. A laser-inscribable film with metallic surface luster produced according to the method of claim 1, having a carrier and at least one laser-inscribable layer (“engraving layer”) arranged above the carrier, wherein a gloss layer is arranged above the engraving layer and in that the gloss layer comprises metal gloss pigments.

17. The film as claimed in claim 16, wherein the gloss layer is formed and printed as a printing lacquer layer.

18. The film as claimed in claim 16, wherein the gloss layer exclusively comprises metal gloss pigments as coloring pigments.

19. The film as claimed in claim 16, wherein the gloss layer has a layer thickness of between about 0.5 μm and about 5 μm.

20. The film as claimed in claim 16, wherein the gloss layer exclusively comprises a transparent binder and the metal gloss pigments as constituents, or in that the gloss layer comprises a transparent binder, the metal gloss pigments and further additives.

21. The film as claimed in claim 16, wherein the metal gloss pigments in the gloss layer do not form a continuous film.
